(19) United States
(12) Patent Application Publication
(10) Pub. No.: US 2013/0229300 A1
(43) Pub. Date: Sep. 5, 2013

(54) ON-BOARD RADAR APPARATUS, OBJECT DETECTION METHOD, AND OBJECT DETECTION PROGRAM

(71) Applicant: HONDA ELESYS CO., LTD., Yokohama-shi (JP)

(72) Inventor: Itaru IZUMI, Yokohama-shi (JP)

(73) Assignee: Honda elesys Co., Ltd., Yokohama-shi (JP)

(21) Appl. No.: 13/665,252

(22) Filed: Oct. 31, 2012

(30) Foreign Application Priority Data
Nov. 2, 2011 (JP) 2011-241467

(51) Int. Cl. G01S 13/46

(52) U.S. Cl. CPC G01S 13/46
USPC 342/156

(57) ABSTRACT

An on-board radar apparatus includes a plurality of reception antennas that form a reception array antenna that receives a reception wave obtained by causing an object to reflect a transmitted wave, the reception array antenna having two or more average pitches that do not have the relationship of integral multiplication, and an azimuth detecting unit configured to perform an azimuth detection process of detecting an azimuth of the target based on signals received by the respective reception array antennas, and to determine that the detected azimuth of the target is a real azimuth when it is determined that the azimuths of the target detected based on the signals received by the respective reception array antennas coincide with each other and to determine that the detected azimuth of the target is a pseudo azimuth when it is determined that the azimuths of the target detected based on the signals received by the respective reception array antennas do not coincide with each other.

### CROSS-REFERENCE TO RELATED APPLICATIONS

Priority is claimed on Japanese Patent Application No. 2011-241467 filed Nov. 2, 2011, the contents of which are entirely incorporated herein by reference.

### BACKGROUND OF THE INVENTION

1. Field of the Invention

The present invention relates to an on-board radar apparatus, an object detection method, and an object detection program.

2. Description of Related Art

In recent years, in order to enhance convenience and safety in a vehicle such as an automobile, there has been considerable activity regarding the mounting of an on-board radar apparatus that uses a millimeter wave radar, as a sensing apparatus.

In particular, as a longitudinal detection technique, an FMCW (Frequency Modulated Continuous Wave) technique in which the distance and relative velocity with respect to a target (object) can be simultaneously acquired has been generally used. Furthermore, as a transverse detection technique, a technique performing azimuth detection of a target according to DBF (digital beam forming) or separation of the target according to MUSIC (MUltiple SIgnal Classification) has been generally known.

Here, the on-board radar apparatus is mounted in a front portion of the vehicle, for example, in order to transmit a radio wave (transmission wave) in front of the vehicle and to detect (sense) information relating to a target that is present in front of the vehicle.

In this case, the longitudinal direction represents a direction that is the same as a forward direction (advancing direction) of the vehicle. Furthermore, in this case, the transverse direction represents a direction that has an azimuth (azimuth angle) with respect to the forward direction (advancing direction) of the vehicle.

In the on-board radar apparatus using the FMCW technique, a modulated wave is transmitted from a transmission antenna, a reflected wave from a reflection object (target) is received by an array antenna in which reception antennas are arranged, and the received signal is mixed by a mixer to generate a beat signal. Then, the beat signal is converted into a digital signal by an A/D (Analog to Digital) converter to be imported, and the digital signal is subject to FFT (Fast Fourier Transform) to extract a frequency component with respect to the reflection object. Then, the frequency components extracted in an increasing section and a decreasing section of the modulated frequency are combined, to thereby calculate the relative velocity and distance from the target.

Furthermore, in the on-board radar apparatus, azimuth detection using signal processing such as DBF or a high resolution algorithm is performed for the frequency component with respect to the reflection object, to detect the azimuth of the target.

However, in the related art, a range where the azimuth detection is possible (azimuth detection range) is a range where the phase in the element interval of the reception array antenna is shifted by 180°. Here, when the phase is shifted by 180° or more, an aliasing range occurs where it is difficult to determine whether the azimuth is on the right or on the left.

In this specification, the azimuth detection range is referred to as an FOV (Field Of View).

FIG. 10 is a block diagram illustrating a configuration of a reception array antenna having a regular pitch.

The reception array antenna having the regular pitch shown in FIG. 10 has a configuration in which five reception antennas (reception elements) 801-1 to 801-5 are arranged in a line at regular intervals (pitches) d0.

Here, the number of the reception antennas that form the reception array antenna may be a different number.

In the related art, a beat signal received and obtained by the array antenna having a regular pitch in which the respective reception elements of the array antenna are arranged at regular intervals in this manner is subject to an FFT process to extract the frequency component with respect to the reflection object (target), and the azimuth detection using signal processing such as DBF or high resolution algorithm is performed for the frequency component with respect to the reflection object. In this case, when a phase difference that is equal to or larger than a predetermined value occurs in the array antenna, it is difficult to determine whether the target is in or outside the azimuth detection range, and thus, it is difficult to determine whether the azimuth of the target is on the right or on the left.

In this manner, in the related art, in the calculated azimuth detection result, there is a case where the target that is present outside the azimuth detection range is detected at the aliasing position in the azimuth detection range.

Solutions to the above problem have been proposed in the related art.

For example, as a configuration for enlarging the azimuth detection range, a configuration in which the element interval of the reception array antenna is narrowed or a configuration in which the number of the reception elements is increased has been proposed.

However, in such a configuration, since the element interval of the reception array antenna is narrowed or the number of the reception elements is increased in order to enlarge the aximuth detection range, for example, a large number of expensive parts should be used, which causes many problems in realization.

As another example, a technique in which the size of reflection level of the target is determined and it is determined whether the target is in the azimuth detection range has been proposed.

However, in such a technique, there is a problem in that a target that is in the azimuth detection range but has a low reflection level may be mistakenly determined as a target that is outside the azimuth detection range.

Furthermore, as another example, a technique in which it is determined whether a peak is present at a predicted aliasing position of the azimuth detection range has been proposed.

However, in such a technique, there is a problem in that false determination may be performed.

For reference, Japanese Unexamined Patent Application, First Publication No. 2004-170371 discloses an azimuth detection apparatus in which at least one of a transmission antenna and a reception antenna is plurally provided, a radio wave is transmitted and received through each channel formed by combination of the transmission antenna and the reception antenna, and the azimuth of a target that reflects the radio wave is detected on the basis of a phase difference between reception signals received through the respective channels. Here, assuming that the phase difference is present in the range of −π [rad] to +π [rad], the azimuth of the target is calculated on the basis of the phase difference between the reception signals. Then, it is determined which one of azimuth angle ranges corresponding to the phase difference ranges of (2m−1) π [rad] to (2 m+1) π [rad] (here, m is an integer), respectively, the target is present in. Then, the azimuth calculated by the azimuth calculation is corrected according to the determination result.

### SUMMARY OF THE INVENTION

As described above, in the on-board radar apparatus, when the azimuth detection of the target is performed using signal processing such as DBF or a high resolution algorithm, the target that is present outside the azimuth detection range may be detected at the aliasing position in the azimuth detection range.

In order to solve this problem, solutions have been proposed in the related art, but it is desirable to develop an improved solution.

Accordingly, an advantage of some aspects of the invention is to provide an on-board radar apparatus, an object detection method, and an object detection program that are capable of determining whether an object that is present in an azimuth detection range is detected or an object that is outside the azimuth detection range is detected at an aliasing position in the azimuth detection range.

(1) According to a first aspect of the invention, an on-board radar apparatus is provided including: a plurality of reception antennas that form a reception array antenna that receives a reception wave obtained by causing an object to reflect a transmitted wave, the reception array antenna having two or more average pitches that does not have the relationship of integral multiplication; and an azimuth detecting unit configured to perform an azimuth detection process of detecting an azimuth of the target based on signals received by the respective reception array antennas, and to determine that the detected azimuth of the target is a real azimuth when it is determined that the azimuths of the target detected based on the signals received by the respective reception array antennas coincide with each other and to determine that the detected azimuth of the target is a pseudo azimuth when it is determined that the azimuths of the target detected based on the signals received by the respective reception array antennas do not coincide with each other.

(2) According to another aspect of the invention, in the on-board radar apparatus according to (1), the azimuth detecting unit may determine that the target is present in an azimuth detection range (in the narrowest azimuth detection range among the azimuth detection ranges of the azimuth detection process performed based on the signals received by the respective reception array antennas) in the azimuth detection process when the azimuths of the target detected based on the signals received by the respective reception array antennas coincide with each other, and may determine that the target is present outside the azimuth detection range (outside the narrowest azimuth detection range among the azimuth detection ranges of the azimuth detection process performed based on the signals received by the respective reception array antennas) in the azimuth detection process when the azimuths of the target detected based on the signals received by the respective reception array antennas do not coincide with each other.

(3) According to another aspect of the invention, the on-board radar apparatus according to (1) or (2) may further include a table configured to store matching of the position relationship between the azimuths of the target detected based on the signals received by the respective reception array antennas and an azimuth where the target is actually present, based on the assumption of one-time aliasing of the narrowest azimuth detection range in the azimuth detection process, and when it is determined that the azimuths of the target detected based on the signals received by the respective reception array antennas do not coincide with each other, the azimuth detecting unit may detect the azimuth where the target is actually present, based on the assumption of one-time aliasing of the narrowest azimuth detection range in the azimuth detection process, from the position relationship between the azimuths of the target detected based on the signals received by the respective reception array antennas based on the matching stored in the table.

(4) According to another aspect of the invention, an object detection method is provided including: using a plurality of reception antennas that form a reception array antenna that receives a reception wave obtained by causing an object to reflect a transmitted wave, the reception array antenna having two or more average pitches that does not have the relationship of integral multiplication; and performing an azimuth detection process of detecting an azimuth of the target based on signals received by the respective reception array antennas, and determining that the detected azimuth of the target is a real azimuth when it is determined that the azimuths of the target detected based on the signals received by the respective reception array antennas coincide with each other and determining that the detected azimuth of the target is a pseudo azimuth when it is determined that the azimuths of the target detected based on the signals received by the respective reception array antennas do not coincide with each other, by an azimuth detecting unit.

(5) According to another aspect of the invention, an object detection program is provided that causes a computer to execute a routine including: using a plurality of reception antennas that form a reception array antenna that receives a reception wave obtained by causing an object to reflect a transmitted wave, the reception array antenna having two or more average pitches that does not have the relationship of integral multiplication; and performing an azimuth detection process of detecting an azimuth of the target based on signals received by the respective reception array antennas, and determining that the detected azimuth of the target is a real azimuth when it is determined that the azimuths of the target detected based on the signals received by the respective reception array antennas coincide with each other and determining that the detected azimuth of the target is a pseudo azimuth when it is determined that the azimuths of the target detected based on the signals received by the respective reception array antennas do not coincide with each other, by an azimuth detecting unit.

As described above, according to the various aspects of the invention, it is possible to provide an on-board radar apparatus, an object detection method, and an object detection program that are capable of determining whether an object that is present in an azimuth detection range is detected or an object that is outside the azimuth detection range is detected at an aliasing position in the azimuth detection range.

### BRIEF DESCRIPTION OF THE DRAWINGS

FIG. 1 is a block diagram illustrating a configuration of an on-board radar apparatus according to an embodiment of the invention.

Part (a) of FIG. 2 is a block diagram illustrating a configuration of a reception array antenna having irregular pitches according to an embodiment of the invention, and Part (b) of FIG. 2 is a block diagram illustrating a part of reception antennas that form a reception array antenna having irregular pitches according to an embodiment of the invention.

FIG. 3 is a flowchart illustrating an example of a process routine performed in an azimuth detecting unit according to an embodiment of the invention.

FIG. 4 is a flowchart illustrating another example of a process routine performed in an azimuth detecting unit according to an embodiment of the invention.

Part (a) of FIG. 5 is a diagram illustrating an example of a target detection state when a target is present in an azimuth detection range (FOV), Part (b) of FIG. 5 is a diagram illustrating an example of a target detection state when the target is present outside (on the left side of) the azimuth detection range (FOV), and Part (c) of FIG. 5 is a diagram illustrating an example of a target detection state when the target is present outside (on the right side of) the azimuth detection range (FOV).

Part (a) of FIG. 6 is a diagram illustrating the relationship between a host vehicle and a different vehicle in simulation, and Part (b) of FIG. 6 is a diagram illustrating simulation conditions.

FIG. 7 is a diagram illustrating simulation results relating to a radar apparatus according to an embodiment of the invention.

Part (a) of FIG. 8 is a diagram illustrating the relationship between a host vehicle and a corner reflector in simulation of a real machine, and Part (b) of FIG. 8 is a diagram illustrating simulation conditions in a real machine.

FIG. 9 is a diagram illustrating simulation results in a real machine relating to a radar apparatus according to an embodiment of the invention.

FIG. 10 is a block diagram illustrating a configuration of a reception array antenna having a regular pitch.

### DETAILED DESCRIPTION OF THE INVENTION

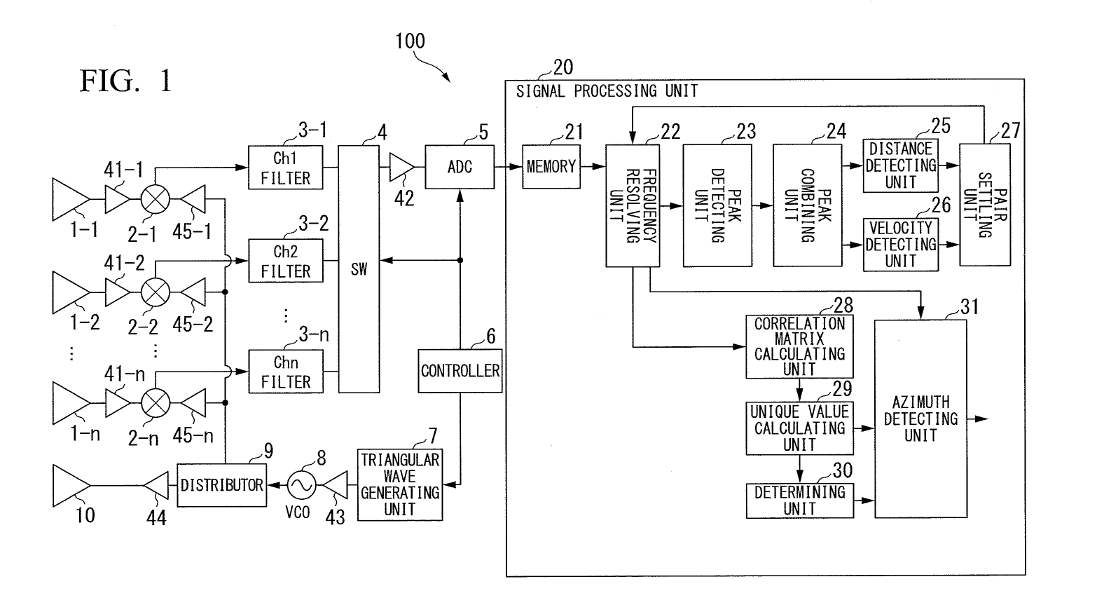

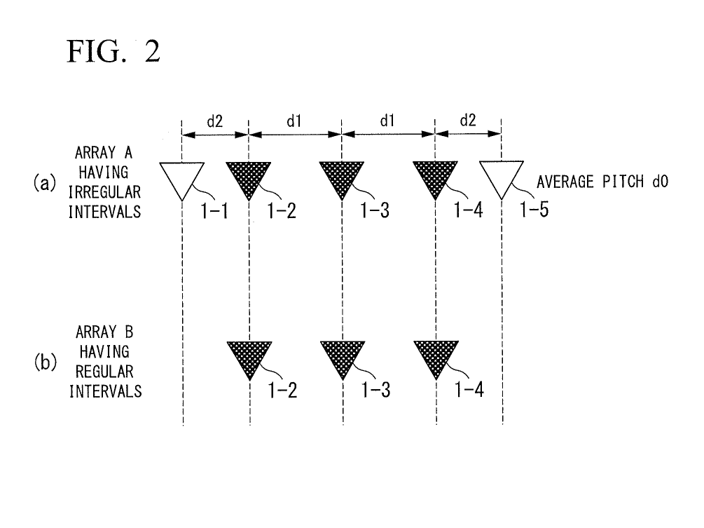

FIG. 1 is a block diagram illustrating a configuration of an on-board radar apparatus 100 according to an embodiment of the invention.

In the present embodiment, as an example of the on-board radar apparatus, an electronic scanning radar apparatus (millimeter wave FMCW radar apparatus) is used.

The on-board radar apparatus 100 according to the present embodiment is mounted in a front portion of a vehicle (in the present embodiment, an automobile, for example) in order to transmit a radio wave (transmission wave) in front of the vehicle and to detect (sense) information about a target that is present in front of the vehicle.

The radar apparatus 100 according to the present embodiment includes n (n is a plural number) reception antennas (reception elements) 1-1 to 1-n, n mixers 2-1 to 2-n, n filters 3-1 to 3-n, a switch (SW) 4, an A/D converter (ADC) 5, a controller 6, a triangular wave generating unit 7, a voltage controlled oscillator (VCO) 8, a distributor 9, a transmission antenna 10, and a signal processing unit 20.

Furthermore, the radar apparatus 100 according to the present embodiment includes n amplifiers 41-1 to 41-n, an amplifier 42, an amplifier 43, an amplifier 44, and n amplifiers 45-1 to 45-n.

Here, the radar apparatus 100 according to the present embodiment includes a reception system having n channels (Ch) that form a reception array antenna. For each channel, each of the reception antennas 1-1 to 1-n, each of the amplifiers 41-1 to 41-n, each of the mixers 2-1 to 2-n, each of the filters 3-1 to 3-n, and each of the amplifiers 45-1 to 45-n are provided.

In the present embodiment, as an example, a case where n is 5 is used.

The signal processing unit 20 includes a memory 21, a frequency separating unit 22, a peak detecting unit 23, a peak combining unit 24, a distance detecting unit 25, a velocity detecting unit 26, a pair settling unit 27, a correlation matrix calculating unit 28, a unique value calculating unit 29, a determining unit 30, and an azimuth detecting unit 31.

An example of a schematic operation performed in the radar apparatus 100 according to the present embodiment will be described.

The triangular wave generating unit 7 generates a triangular wave signal and outputs the result to the amplifier 43, under the control of the controller 6.

The amplifier 43 amplifies the triangular wave signal input from the triangular wave generating unit 7 and outputs the result to the VCO 8.

The VCO 8 outputs a signal obtained by performing frequency modulation for the triangular wave signal, based on the triangular wave signal input from the amplifier 43, to the distributor 9 as a transmission signal.

The distributor 9 distributes the transmission signal input from the VCO 8 into two, and outputs one distributed signal to the amplifier 44 and the other distributed signal to the respective amplifiers 45-1 to 45-n.

The amplifier 44 amplifies the signal input from the distributor 9 and outputs the result to the transmission antenna 10.

The transmission antenna 10 transmits the signal input from the amplifier 44 as a transmission wave in a wireless manner.

The transmission wave is reflected by a target.

Each of the reception antennas 1-1 to 1-n receives a reflected wave (that is, a reception wave) that is obtained by causing the target to reflect a transmitted wave transmitted from the transmission antenna 10, and outputs the received reception wave to each of the amplifiers 41-1 to 41-n.

Each of the amplifiers 41-1 to 41-n amplifies the reception wave input from each of the antenna 1-1 to 1-n, and outputs the result to each of the mixers 2-1 to 2-n.

Each of the amplifiers 45-1 to 45-n amplifies the signal (signal distributed from the transmission signal) input from the distributor 9, and outputs the result to each of the mixers 2-1 to 2-n.

Each of the respective mixers 2-1 to 2-n mixes the signal input from each of the amplifiers 41-1 to 41-n with the signal (signal of the transmission wave transmitted from the transmission antenna 10) input from each of the amplifiers 45-1 to 45-n, generates a beat signal corresponding to each frequency difference, and outputs the generated beat signal to each of the filters 3-1 to 3-n.

Each of the filters 3-1 to 3-n performs region limitation for the beat signal (beat signal of each of the channels 1 to n corresponding to each of the reception antennas 1-1 to 1-n) input from each of the mixers 2-1 to 2-n, and outputs the region-limited beat signal to the switch 4.

The switch 4 sequentially switches the beat signals input from the respective filters 3-1 to 3-n, corresponding to sampling signals input from the controller 6, and outputs the result to the amplifier 42.

The amplifier 42 amplifies the beat signal input from the switch 4, and outputs the result to the A/D converter 5.

The A/D converter 5 A/D converts, in synchronization with the sampling signal, the beat signal (beat signal of each of the channels 1 to n corresponding to each of the reception antenna 1-1 to 1-n) input from the switch 4 in synchronization with the sampling signal, corresponding to the sampling signal input from the controller 6 to convert an analog signal into a digital signal, and sequentially stores the digital signals obtained in this manner in a waveform storage region of the memory 21 in the signal processing unit 20.

The controller 6 is configured by a microcomputer or the like, for example.

The controller 6 performs an overall control of the radar apparatus 100 based on a control program stored in a ROM (Read Only Memory) or the like (not shown).

As a specific example, the controller 6 controls a process of generating the triangular wave signal by the triangular wave generating unit 7, and further generates a predetermined sampling signal and outputs the result to the switch 4 and the A/D converter 5.

Next, an example of a schematic operation performed in the signal processing unit 20 will be described.

The memory 21 stores the digital signal (beat signal) obtained by the A/D converter 5 in the waveform storage region thereof, corresponding to each of the antennas 1-1 to 1-n. This digital signal is made of time series data having an ascending portion and a descending portion.

For example, when 256 values are sampled in each of the ascending portion and the descending portion, data of 2×256×number of antennas is stored in the waveform storage region of the memory 21.

The frequency resolving unit 22 converts the beat signal corresponding to each of the channels 1 to n (each of the antennas 1-1 to 1-n) into a frequency component according to a predetermined resolution using frequency conversion (for example, Fourier transform, DTC, Hadamard transform, Wavelet transform or the like), and outputs a frequency point indicating the beat frequency obtained in this manner and complex data on the beat frequency to the peak detecting unit 23, the correlation matrix calculating unit 28 and the azimuth detecting unit 31.

This process will be specifically described.

In the radar apparatus 100 according to the present embodiment, the reception signal that is the reflected wave from the target is delayed and received in a time delay direction (for example, in the right direction of a graph (not shown)) in proportion to the distance between the radar apparatus 100 and the target, with respect to the transmission signal. Furthermore, the reception signal is changed in a frequency direction (for example, in the vertical direction of a graph (not shown)) with respect to the transmission signal, in proportion to a relative velocity between the radar apparatus 100 and the target.

In this regard, when the beat signal is frequency-converted, when the number of the target is one, each of an ascending portion (ascending region) and a descending portion (descending region) of the triangular wave has one peak value.

The frequency resolving unit 22 frequency-converts data obtained by sampling the beat signal stored in the memory 21 in a discrete time manner using frequency resolution (for example, Fourier transform or the like), with respect to each of the ascending portion (rise) and the descending portion (fall) of the triangular wave. That is, the frequency resolving unit 22 frequency-resolves the beat signal into a beat frequency having a predetermined frequency band width, and calculates complex data based on the beat signal resolved into each beat frequency.

As a result, in each of the ascending portion and the descending portion of the triangular wave, a signal level for each beat frequency obtained by the frequency resolution is obtained. The result is output to the peak detecting unit 23, the correlation matrix calculating unit 28 and the azimuth detecting unit 31.

For example, when each of the ascending portion and the descending portion of the triangular wave has 256 pieces of sampled data for each of the reception antennas 1-1 to 1-n, 128 pieces of complex data (data of 2×128×number of antennas) are present for each of the ascending portion and the descending portion of the triangular wave.

Here, a phase difference that depends on a predetermined angle 8 is present in the complex data for each of the reception antennas 1-1 to 1-n, and an absolute value (for example, reception intensity, amplitude or the like) of each complex data on a complex plane has an equal value.

Then, the predetermined angle θ will be described.

A case where the reception antennas 1-1 to 1-n are arranged in an array form will be described.

The returning wave from the target (incident wave, that is, the reflected wave from the target corresponding to the transmission wave transmitted from the transmission antenna 10) that is incident at the angle θ with respect to an axis perpendicular to a plane on which the antennas are arranged is input to the reception antennas 1-1 to 1-n.

At this time, the returning wave is received at the same angle θ in the reception antennas 1-1 to 1-n.

A phase difference (value that is proportional to a path difference “d·sin θ”) obtained by the same angle θ and an interval d between any adjacent two reception antennas among the reception antennas 1-1 to 1-n occurs between the adjacent two reception antennas 1-1 to 1-n.

By performing azimuth detection using signal processing such as DBF or high resolution algorithm using the phase difference, it is possible to detect the azimuth (angle θ) of the target.

The peak detecting unit 23 detects a beat frequency having a peak value (for example, a peak value of reception intensity, amplitude or the like) of the complex data that exceeds a predetermined value in each of the ascending portion and the descending portion of the triangular wave based on the information input from the frequency resolving unit 22 to detect (sense) the presence of the target for beat frequency, and selects the beat frequency corresponding to the detected target as a target frequency. The peak detecting unit 23 outputs the detection result of the target frequency (the beat frequency of the target frequency and the peak value thereof) to the peak combining unit 24.

In this regard, in the peak detecting unit 23, for example, it is possible to detect, on the basis of a frequency spectrum of the complex data relating to any one of the reception antennas 1-1 to 1-n or a frequency spectrum of an addition value of the complex data relating to the entire reception antennas 1-1 to 1-n, the beat frequency corresponding to each peak value in the frequency spectrum as a target frequency. Here, when the addition value of the complex data of the entire reception antennas 1-1 to 1-n is used, it is expected that a noise component is averaged to enhance the S/N ratio (signal-to-noise ratio). The peak combining unit 24 combines, in a round-robin manner, the beat frequencies and the peak values thereof in each of the ascending portion and the descending portion in a matrix format, with respect to the information (the beat frequency of the target frequency and the peak value thereof) input from the peak detecting unit 23 to thereby combine all the beat frequencies in each of the ascending portion and the descending portion, and sequentially outputs the combination result to the distance detecting unit 25 and the velocity detecting unit 26.

The distance detecting unit 25 calculates a distance r from the target based on a value obtained by summing the beat frequencies (target frequencies) in combination of the ascending portion and the descending portion, sequentially input from the peak combining unit 24, and outputs the result (including the peak value as an example) to the pair settling unit 27.

The distance r is expressed by Equation (1).

r={C·T/(2·Δf)}·{(fu+fd)/2} (1)

Here, C represents the speed of light, T represents a modulation time (ascending portion or descending portion), and Δf represents a frequency modulation width of the triangular wave. Furthermore, fu represents the target frequency of the ascending portion of the triangular wave output from the peak combining unit 24, and fd represents the target frequency of the descending portion of the triangular wave output from the peak combining unit 24.

The velocity detecting unit 26 calculates a relative velocity v with respect to the target based on a difference value of the beat frequencies (target frequencies) in combination of the ascending portion and the descending portion sequentially input from the peak combining unit 24, and outputs the result (including the peak value as an example) to the pair settling unit 27.

The relative velocity v is expressed by Equation (2).

v={C/(2·f0)}·{(fu−fd)/2} (2)

Here, f0 represents a central frequency of the triangular wave.

The pair settling unit 27 determines an appropriate combination of the respective peaks of each of the ascending portion and the descending portion corresponding to each target, based on the information input from the distance detecting unit 25 and the information input from the velocity detecting unit 26, settles a pair of the respective peaks of each of the ascending portion and the descending portion, and outputs a target group number indicating the settled pair (distance r, relative velocity v and frequency point) to the frequency separating unit 22.

Here, since the azimuth is not determined in each target group, a transverse position that is in parallel with the arrangement direction of the reception antennas 1-1 to 1-n is not determined with respect to an axis perpendicular to the arrangement direction of the reception antenna array in the radar apparatus 100 according to the present embodiment.

The correlation matrix calculating unit 28 calculates a predetermined correlation matrix based on the information input from the frequency resolving unit 22, and outputs the result to the unique value calculating unit 29.

The unique value calculating unit 29 calculates a unique value based on the information input from the correlation matrix calculating unit 28, and outputs the result to the determining unit 30 and the azimuth detecting unit 31.

The determining unit 30 determines the degree based on the information input from the unique value calculating unit 29, and outputs the result to the azimuth detecting unit 31.

The azimuth detecting unit 31 detects the azimuth (azimuth angle) of the target based on the information input from the frequency resolving unit 22, the information input from the unique value calculating unit 29, and the information input from the determining unit 30, and outputs the result.

Here, as a method (for example, algorithm) used for detecting the azimuth of the target using the azimuth detecting unit 31, various methods including known methods may be used, except for a characteristic point of the radar apparatus 100 according to the present embodiment relating to azimuth detection to be described later.

As a specific example, the azimuth detecting unit 31 may perform a spectrum estimation process using an AR spectrum estimation method, a MUSIC method or the like that is a high resolution algorithm, and may detect the azimuth of the target based on the result of the spectrum estimation process. In the present embodiment, a modified covariance method (MCOV method) is used.

Furthermore, the components corresponding to the correlation matrix calculating unit 28, the unique value calculating unit 29, the determining unit 30 and the azimuth detecting unit 31 (in this example, the components that calculate the correlation matrix, unique value and degree, and detect the azimuth of the target) may use configurations and operations suitable for the azimuth detection method used in the signal processing unit 20, which may be configurations and operations that are different from those of the present embodiment.

Furthermore, as the azimuth detection method, the DBF or the like may be used as another example.

As a principle of detecting the distance, relative velocity and azimuth (azimuth angle) with respect to the target, it is possible to use a known technique disclosed in Japanese Unexamined Patent Application, First Publication No. 2011-163883 or the like, for example, except for the characteristic point of the radar apparatus 100 according to the present embodiment relating to azimuth detection to be described later.

Next, the characteristic point of the radar apparatus 100 according to the present embodiment relating to the azimuth detection will be described.

In the present embodiment, as the reception array antenna that is configured by n reception antennas, a reception array antenna having irregular pitches is used.

Part (a) of FIG. 2 is a block diagram illustrating a configuration of the reception array antenna having irregular pitches according to an embodiment of the invention.

Part (b) of FIG. 2 is a block diagram illustrating a part of the reception antennas that forms the reception array antenna having irregular pitches according to the present embodiment.

As shown in Part (a) of FIG. 2, the reception array antenna having irregular pitches according to the present embodiment is configured so that n (in the present embodiment, n=5) reception antennas 1-1 to 1-5 are arranged in a line.

An interval (pitch) between the first reception antenna 1-1 and the second reception antenna 1-2 is d2, an interval between the second reception antenna 1-2 and the third reception antenna 1-3 is d1, an interval between the third reception antenna 1-3 and the fourth reception antenna 1-4 is d1, and an interval between the fourth reception antenna 1-4 and the fifth reception antenna 1-5 is d2.

Here, the interval d1 and the interval d2 are different values (d1≠d2). In the present embodiment, d1 is larger than d2 (d1>d2).

Furthermore, the interval d1 and the interval d2 do not have the relationship of integral multiplication (d1≠p·d2: p=1, 2, 3, . . . ).

Furthermore, with respect to all the reception antennas 1-1 to 1-5, an average value (average pitch) of the intervals of adjacent reception antennas is set to d0 (d0=(d2+d1+d1+d2)/4).

In the reception array antenna configured by the n reception antennas 1-1 to 1-n, when i=1, 2, . . . (n−1), the intervals of (n−1) adjacent reception antennas are respectively expressed as d(i), the average interval (average pitch) d0 with respect to all the reception antennas 1-1 to 1-n is expressed by Equation (3).

d0=Σd(i)/(n−1)(Σ represents the sum when i=1 to (n−1)) (3)

As shown in Part (b) of FIG. 2, it is possible to use a part of the reception antennas that form the reception array antenna having irregular pitches according to the present embodiment.

In this example, the second reception antenna 1-2, the third reception antenna 1-3, and the fourth reception antenna 1-4 are used as three reception antennas. In this case, the intervals of the adjacent reception antennas are all set to a regular interval d1.

As an example, the partial use of only the reception antennas 1-2 to 1-4 as described above may be realized by a configuration in which the controller 6 or the like performs a control so that a process relating to a signal received by the reception antennas 1-2 to 1-4 that are used is performed by the signal processing unit 20 and a process relating to a signal received by the reception antennas 1-1 and 1-5 that are not used is not performed by the signal processing unit 20.

As another example, the partial use of only the reception antennas 1-2 to 1-4 as described above may be realized by a configuration in which connection of the reception antennas 1-2 to 1-4 that are used is performed by a switch or the like and connection of the reception antennas 1-1 and 1-5 that are not used is not performed by a switch or the like, using the controller 6 or the like.

In the present embodiment, it is assumed that the reception array antenna having irregular pitches that uses all the reception antennas 1-1 to 1-5, as shown in Part (a) of FIG. 2, is referred to as an “A type” (type of array A having irregular intervals of five channels), and the reception array antenna having a regular pitch that uses the partial reception antennas 1-2 to 1-4 is referred to as a “B type” (type of array B having a regular pitch of three channels), as shown in Part (a) of FIG. 2.

In the present embodiment, schematically, reflected waves from the target (reflection object) are received using the arrangement of the reception antennas shown in Part (a) of FIG. 2 (or Part (b) of FIG. 2) and the mixers 2-1 to 2-n mix the received reflected waves to generate a beat signal. The beat signal is converted into a digital signal by the A/D converter 5 to be imported to the memory 21 and is subject to an FFT process by the frequency resolving unit 22 of the signal processing unit 20, and then, a frequency component with respect to the reflection object is extracted. Furthermore, on the basis of combination of the frequency components extracted in an increasing section (ascending portion) and a decreasing section (descending portion) of the modulated frequency, the distance between the radar apparatus 100 according to the present embodiment and the target and the relative velocity are calculated.

Furthermore, with respect to the frequency component with respect to the reflection object extracted by the frequency resolving unit 22 of the signal processing unit 20, the azimuth of the target is detected by the azimuth detecting unit 31.

In this case, in the algorithm used in the azimuth detecting unit 31, a target that is present in the azimuth detection range is detected as a real thing that is present in the azimuth detection range, but a target that is present outside the azimuth detection range is detected at an aliasing position in the azimuth detection range.

Thus, in the present embodiment, the azimuth detection of the target using all the channels is performed when the reception array antenna having irregular pitches in which the reception antennas are arranged at the different intervals d1 and d2 as in the “A type” shown in Part (a) of FIG. 2 is used, and the azimuth detection of the target using partial channels is performed when the reception array antenna having a regular pitch in which the reception antennas are arranged at the regular intervals d1 as in the “B type” shown in Part (b) of FIG. 2 is used.

Here, in the reception array antenna, the width of the azimuth detection range is determined according to the average value (average pitch) of the intervals of the adjacent reception antennas. In the present embodiment, the widths of the azimuth detection range are different from each other in the “A type” reception array antenna in which the average pitch is d0 (average value of d1 and d2) and the “B type” reception array antenna in which the average pitch is d1. Thus, in combination of the azimuth detection result when the “A type” reception array antenna is used and the azimuth detection result when the “B type” reception array antenna is used, the azimuth detection results match with each other when the target is present in both the azimuth detection ranges (that is, in a narrow azimuth detection range), but a calculation result is obtained in which a difference (shift) occurs in both the azimuth detection results when the target is present outside at least one azimuth detection range (that is, outside at least the narrow azimuth detection range and outside the common portion of two azimuth detection ranges). Such a difference of the azimuth detection results depends on the difference of the azimuth detection ranges.

The difference is used herein. Specifically, when two azimuth detection results match with each other, it is determined that the target is present in the two azimuth detection ranges, that is, it is determined that a real azimuth is detected, and when the two azimuth detection results do not match with each other, it is determined that the target is present outside at least one azimuth detection range, that is, it is determined that a pseudo azimuth is detected. Thus, it is possible to determine whether the target is present in the azimuth detection range (here, the common portion of the two azimuth detection ranges) or outside the azimuth detection range.

Furthermore, in the present embodiment, when the two azimuth detection ranges do not match with each other, it is determined that the target is present outside at least one azimuth detection range, and assuming that aliasing occurs once (in the present embodiment, assuming that aliasing does not occur two or more times with respect to the narrow azimuth detection range), it is possible to determine the azimuth of the target based on the relationship between two azimuth detection results. Thus, it is possible to realize a substantially wide angle of the azimuth detection range, without changing the reception antennas 1-1 to 1-5 provided in the radar apparatus 100.

In this example, since it is assumed that aliasing occurs once with respect to the target that is present outside at least one azimuth detection range, when aliasing occurs two or more times with respect to the narrow azimuth detection range, the azimuth of the target is not accurately determined.

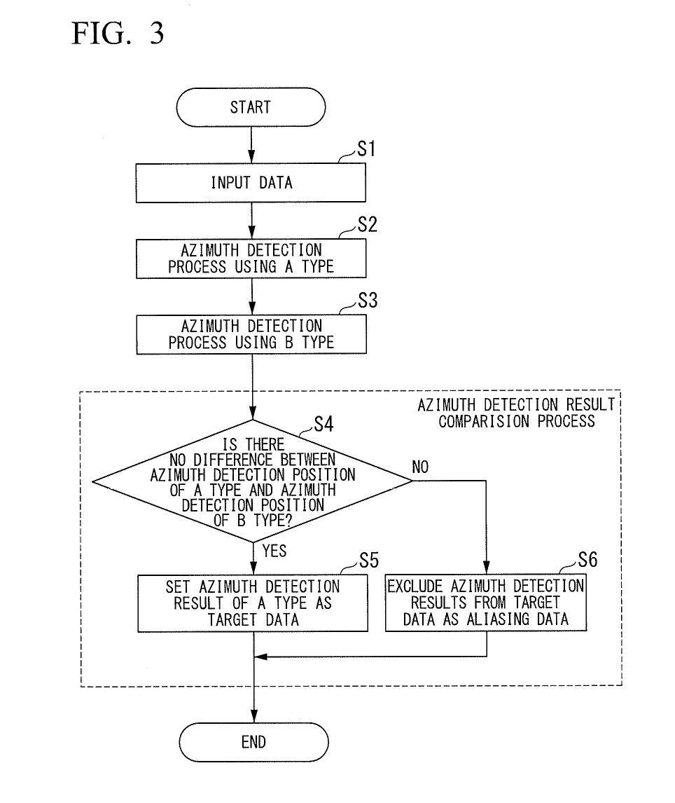

FIG. 3 is a flowchart illustrating an example of a process routine performed in the azimuth detecting unit 31 according to an embodiment of the invention.

The azimuth detecting unit 31 receives an input of data (in the present embodiment, data relating to the frequency component with respect to the reflection object) from the frequency resolving unit 22 (step S1).

In the present embodiment, in step S1, the azimuth detecting unit 31 also receives inputs of data on the unique value calculated by the unique value calculating unit 29 and data on the order determined by the determining unit 30.

Firstly, the azimuth detecting unit 31 performs an azimuth detection process using the array A having irregular intervals that is the “A type”, and detects the azimuth (position of the azimuth angle) of the target (step S2).

Next, the azimuth detecting unit 31 performs the azimuth detection process using the array B having a regular interval that is the “B type”, and detects the azimuth (position of the azimuth angle) of the target (step S3).

The order of the process of step S2 and the process of step S3 may be opposite.

Then, the azimuth detecting unit 31 performs a process of comparing the two azimuth detection results for each target (steps S4 to S6).

Specifically, the azimuth detecting unit 31 determines whether there is a difference between the azimuth detection result (position of the azimuth angle) obtained with respect to the “A type” and the azimuth detection result (position of the azimuth angle) obtained with respect to the “B type” (step S4).

As a determination result, when it is determined that there is no difference between the azimuth detection result (position of the azimuth angle) obtained with respect to the “A type” and the azimuth detection result (position of the azimuth angle) obtained with respect to the “B type”, the azimuth detecting unit 31 determines that the target (real object) is present in the azimuth detection range (here, the common portion of the two azimuth detection ranges), and sets the azimuth detection result (position of the azimuth angle) obtained with respect to the “A type” as data on the azimuth of the target (step S5), for example.

In this case, it is possible to set the azimuth detection result (position of the azimuth angle) obtained with respect to the “B type” as the data on the azimuth of the target, instead of the azimuth detection result (position of the azimuth angle) obtained with respect to the “A type”.

On the other hand, as a determination result, when it is determined that there is a difference between the azimuth detection result (position of the azimuth angle) obtained with respect to the “A type” and the azimuth detection result (position of the azimuth angle) obtained with respect to the “B type”, the azimuth detecting unit 31 determines that the target that is present outside the azimuth detection range (here, the common portion of the two azimuth detection ranges) is detected at an aliasing position in the azimuth detection range (here, the common portion of the two azimuth detection ranges), and excludes the azimuth detection results not to be included in the data relating to the target (step S6).

As a method of determining whether there is a difference between the azimuth detection result (position of the azimuth angle) obtained with respect to the “A type” and the azimuth detection result (position of the azimuth angle) obtained with respect to the “B type”, for example, it is possible to use a method of determining that there is a difference when values of the two azimuth detection results (values indicating the positions of the azimuth angles) are not the same (that is, different from each other) and determining that there is no difference when the values of the two azimuth detection results are the same.

As another example, when a slight error of the values of the two azimuth detection results is allowed, it is possible to use a method of determining that there is a difference when the difference between the values of the two azimuth detection results is equal to or greater than a predetermined threshold value and determining that there is no difference when the difference between the values of the two azimuth detection results is smaller than the threshold value.

In this manner, in an example of the flowchart shown in FIG. 3, the azimuth detecting unit 31 performs the azimuth detection process with respect to the “A type” to calculate azimuth information about the target and performs the azimuth detection process with respect to the “B type” to calculate azimuth information about the target, for the frequency component with respect to the reflection object. After calculating the azimuth information about the target with respect to the two types, the azimuth detecting unit 31 compares the azimuth information about the target obtained with respect to the two types, for each target. Furthermore, the azimuth detecting unit 31 determines that the target is present in the azimuth detection range (here, the common portion of the two azimuth detection ranges) when the azimuth information about the target obtained with respect to the two types matches with each other (error may be allowed), for each target, and then sets the data.

In the example of the flowchart shown in FIG. 3, when the azimuth information about the target obtained with respect to the two types does not match with each other (error may be allowed), the azimuth detecting unit 31 determines that the target is present outside the azimuth detection range (here, the common portion of the two azimuth detection ranges), and excludes the determination result from the data on the target, without retaining the determination result in a status or the like. As another example, when the azimuth information about the target obtained with respect to the two types does not match with each other (error may be allowed), the azimuth detecting unit 31 may determine that the target is present outside the azimuth detection range (here, the common portion of the two azimuth detection ranges), and may retain the determination result in the status or the like.

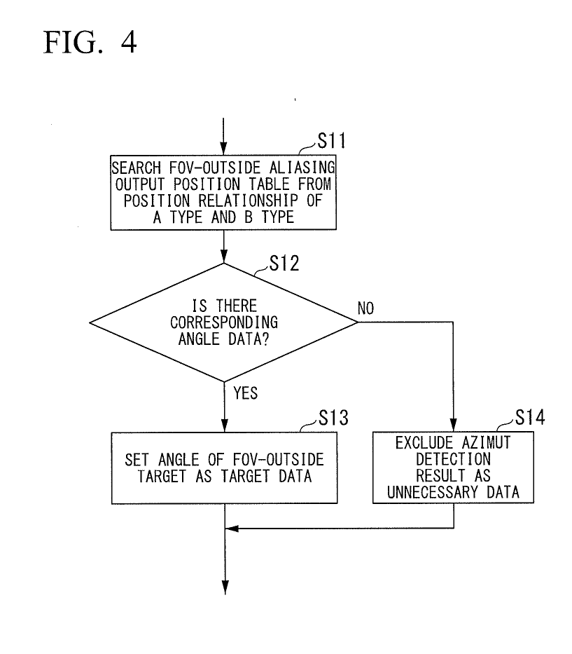

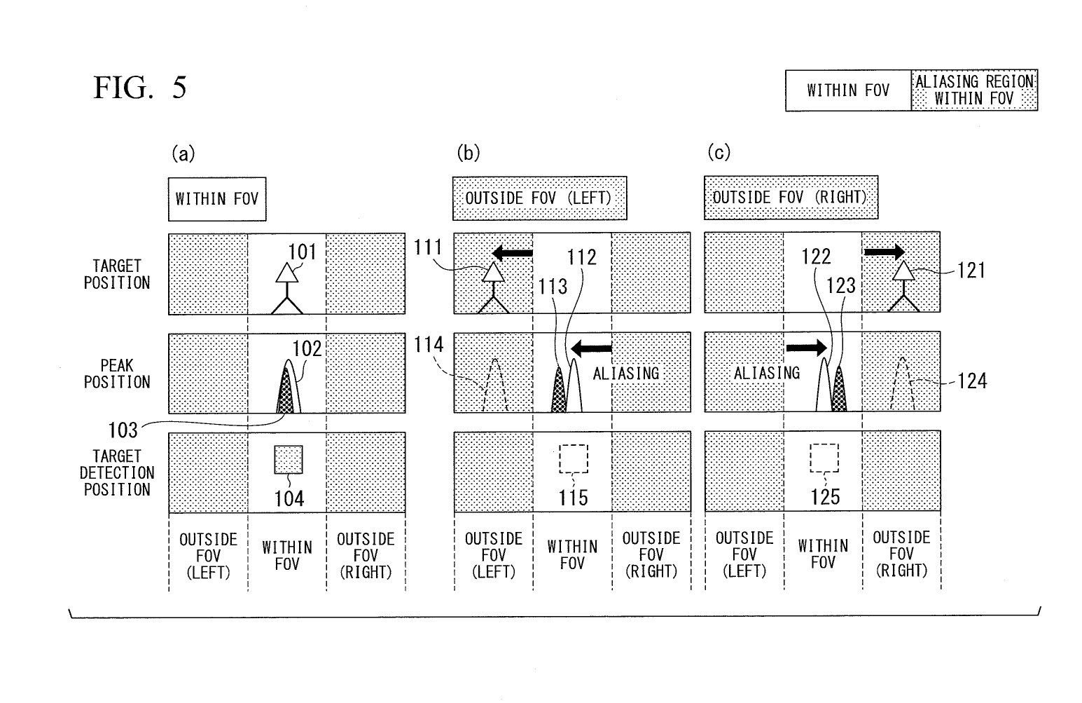

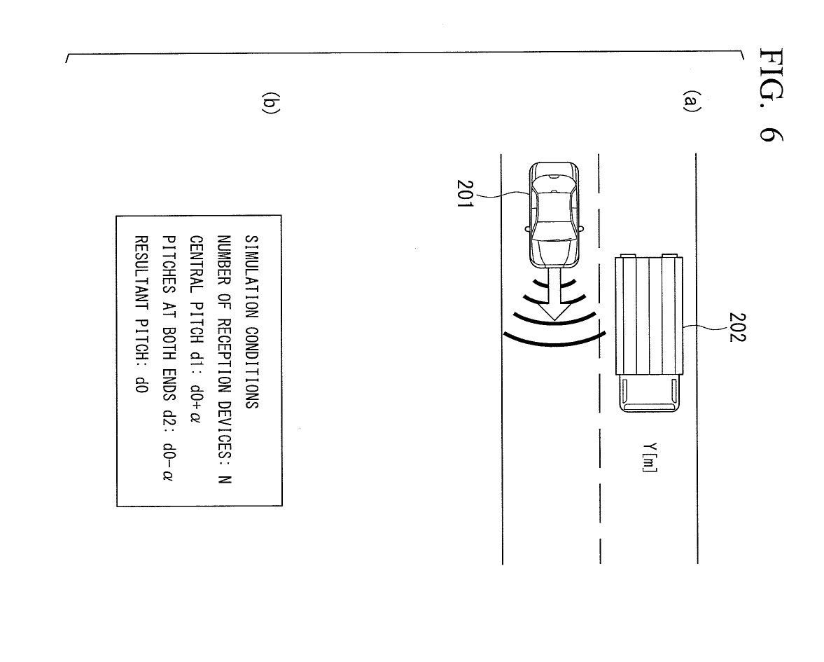

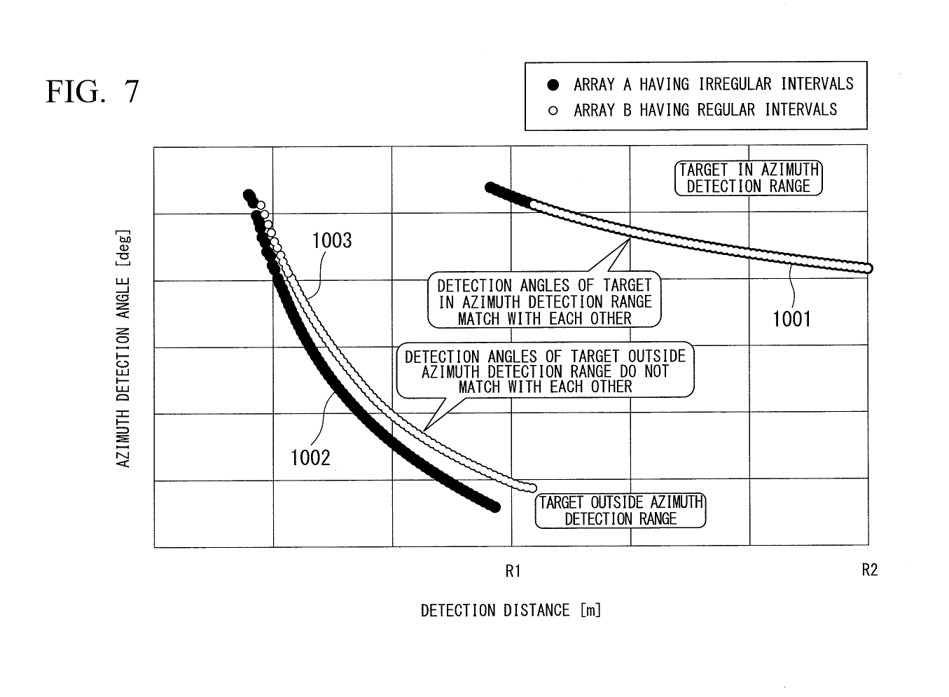

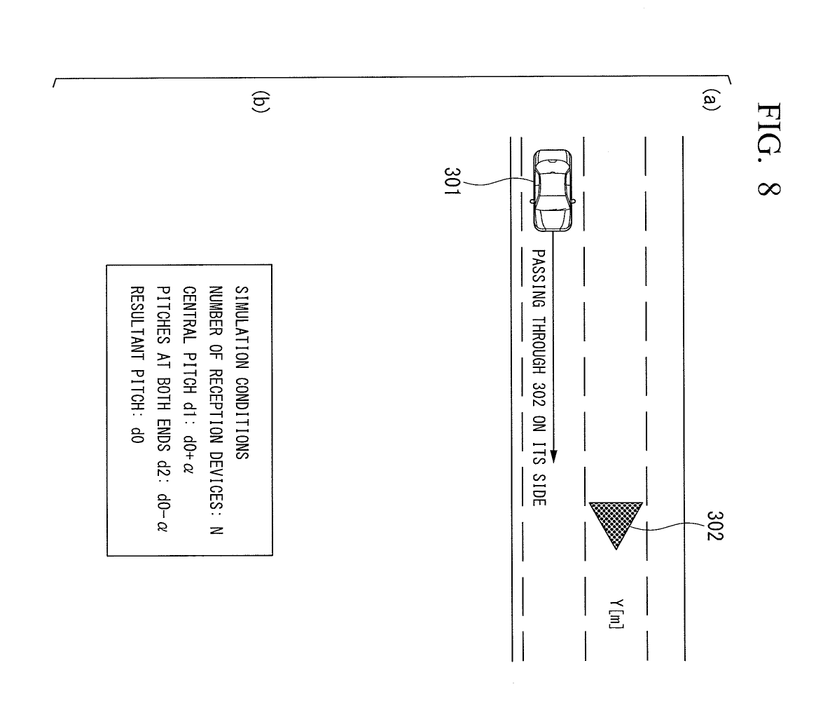

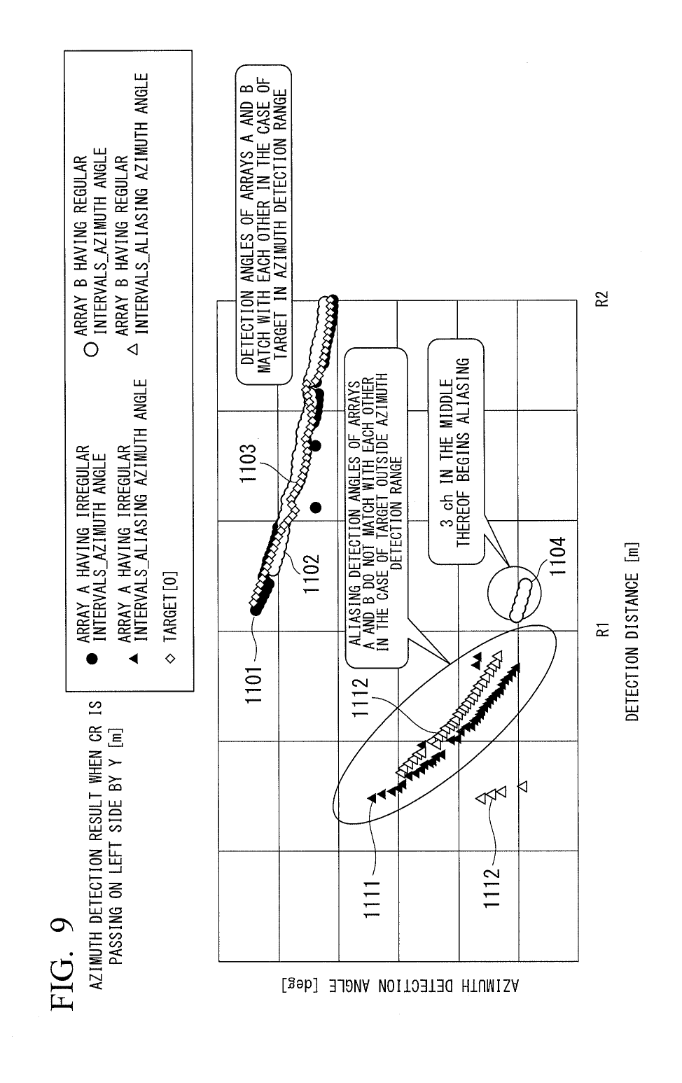

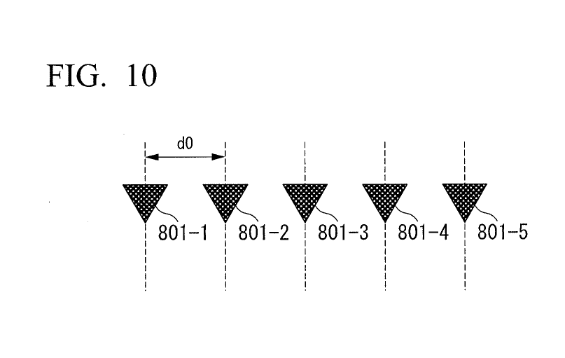

FIG. 4 is a flowchart illustrating another example of a process routine performed in the azimuth detecting unit 31 according to an embodiment of the invention.

Here, a series of processes (processes of steps S11 to S14) shown in FIG. 4 are performed instead of the process of step S6 shown in FIG. 3.

That is, as overall processes, the flowchart in which the processes of steps S1 to S5 in the flowchart shown in FIG. 3 are performed and the processes of steps S11 to S14 shown in FIG. 4 instead of the process of step S6 are performed is obtained.

In the flowchart shown in FIG. 4, as a result of the determination in the process of step S4 shown in FIG. 3, when it is determined that there is a difference between the azimuth detection result (position of the azimuth angle) obtained with respect to the “A type” and the azimuth detection result (position of the azimuth angle) obtained with respect to the “B type”, the azimuth detecting unit 31 determines that the target that is present outside the azimuth detection range (here, the common portion of the two azimuth detection ranges) is detected at the aliasing position in the azimuth detection range (here, the common portion of the two azimuth detection ranges), and performs a process of calculating the azimuth (position of the azimuth angle) of the target based on the assumption of one-time aliasing, without exclusion in this step (step S11).

Specifically, data on a predetermined table (FOV-outside aliasing output position table) is stored in advance in a memory of the azimuth detecting unit 31 or the like.

The FOV-outside aliasing output position table matches the difference relationship (mutual position relationship) between the azimuth detection result (position of the azimuth angle) obtained with respect to the “A type” and the azimuth detection result (position of the azimuth angle) obtained with respect to the “B type” with the azimuth (position of the azimuth angle) in which the target is actually present when one-time aliasing is assumed, for storage. This matching relationship is stored in the FOV-outside aliasing output position table as an initial setting, for example.

Furthermore, as a result of the determination in the process of step S4 shown in FIG. 3, when it is determined that there is a difference between the azimuth detection result (position of the azimuth angle) obtained with respect to the “A type” and the azimuth detection result (position of the azimuth angle) obtained with respect to the “B type”, the azimuth detecting unit 31 determines that the target that is present outside the azimuth detection range (here, the common portion of the two azimuth detection ranges) is detected at the aliasing position in the azimuth detection range (here, the common portion of the two azimuth detection ranges), and searches the azimuth (azimuth where a target is actually present on the assumption of one-time aliasing (position of the azimuth angle)) of the target corresponding to the difference relationship (mutual position relationship) between the azimuth detection result (position of the azimuth angle) obtained with respect to the “A type” and the azimuth detection result (position of the azimuth angle) obtained with respect to the “B type” from the FOV-outside aliasing output position table (step S11).

As a result of the search, when it is determined that the data on the azimuth (position of the azimuth angle) of the corresponding target that is a search target is stored in the FOV-outside aliasing output position table (step S12), the azimuth detecting unit 31 reads the data on the azimuth (position of the azimuth angle) of the corresponding target from the FOV-outside aliasing output position table, and sets the data on the azimuth (position of the azimuth angle) of the read target as data on the azimuth of the target (step S13).

In this case, it is determined that the target is present outside the azimuth detection range (here, the common portion of the two azimuth detection ranges), and the azimuth (position of the azimuth angle) of the corresponding target read from the FOV-outside aliasing output position table becomes an azimuth outside the azimuth detection range (here, the common portion of the two azimuth detection ranges).

On the other hand, as a result of the search, when it is determined that the data on the azimuth (position of the azimuth angle) of the corresponding target that is the search target is not stored in the FOV-outside aliasing output position table (step S12), the azimuth detecting unit 31 determines that the current azimuth detection result is unnecessary data and excludes the azimuth detection result not to be included in the data relating to the target (step S14).

The target detection method will be described in more detail with reference to FIGS. 5 to 9.

Part (a) of FIG. 5 is a diagram illustrating an example of a target detection state when the target is present in the azimuth detection range (FOV).

Part (b) of FIG. 5 is a diagram illustrating an example of a target detection state when the target is present outside (on the left side of) the azimuth detection range (FOV).

Part (c) of FIG. 5 is a diagram illustrating an example of a target detection state when the target is present outside (on the right side of) the azimuth detection range (FOV).

The azimuth detection ranges (FOV) shown in Part (a), Part (b) and Part (c) of FIG. 5 represent a narrow azimuth detection range (FOV) from the “A type” azimuth detection range and the “B type” azimuth detection range. In this example, it is assumed that the “B type” azimuth detection range is narrower than the “A type” azimuth detection range.

Furthermore, the outside (left) of the azimuth detection range (FOV) is one direction of a negative direction and a positive direction in the azimuth of the target, which represents an aliasing region outside of the inside of the azimuth detection range (FOV).

Furthermore, the outside (right) of the azimuth detection range (FOV) is the other direction of the negative direction and the positive direction in the azimuth of the target, which represents an aliasing region that has left the inside of the azimuth detection range (FOV).

In the example shown in Part (a) of FIG. 5, a target 101 is present in the azimuth detection range (FOV).

In this case, a peak position of a spectrum (in this example, spectrum 102) indicating the azimuth (azimuth angle) obtained as the azimuth detection result using the “A type” matches with a peak position of a spectrum (in this example, spectrum 103) indicating the azimuth (azimuth angle) obtained as the azimuth detection result using the “B type”. Thus, a position (target detection position) 104 of the azimuth angle corresponding to the matched peak positions is detected as an azimuth of the target 101.

In the example shown in Part (b) of FIG. 5, a target 111 is present outside (on the left side of) the azimuth detection range (FOV).

In this case, a peak position of a spectrum (in this example, spectrum 112) indicating the azimuth (azimuth angle) obtained as the azimuth detection result using the “A type” does not match with a peak position of a spectrum (in this example, spectrum 113) indicating the azimuth (azimuth angle) obtained as the azimuth detection result using the “B type”. In this example, the peak position of the spectrum 113 is located on the left side, compared with the peak position of the spectrum 112.

At this time, a real azimuth (azimuth when aliasing is not performed) of the target 111 corresponds to a peak position of a spectrum 114, but in the azimuth detection process, the vicinity of a target detection position 115 that is a one-time aliasing position is detected as the azimuth of the target 111.

Here, referring to the relationship of the peak positions of the two spectrums 112 and 113, it may be determined that the aliasing occurs in the left direction. Thus, considering that the aliasing is one-time aliasing, it is possible to determine the real azimuth of the target 111 based on the azimuth detection process result (for example, the relationship of the peak positions of the two spectrums 112 and 113) by considering the aliasing. Thus, it is possible to achieve an effect substantially equivalent to a case where the azimuth detection range (FOV) is widened.

In the example shown in Part (c) of FIG. 5, a target 121 is present outside (on the right side of) the azimuth detection range (FOV).

In this case, a peak position of a spectrum (in this example, spectrum 122) indicating the azimuth (azimuth angle) obtained as the azimuth detection result using the “A type” does not match with a peak position of a spectrum (in this example, spectrum 123) indicating the azimuth (azimuth angle) obtained as the azimuth detection result using the “B type”. In this example, the peak position of the spectrum 123 is located on the right side, compared with the peak position of the spectrum 122.

At this time, a real azimuth (azimuth when aliasing is not performed) of the target 121 corresponds to a peak position of a spectrum 124, but in the azimuth detection process, the vicinity of a target detection position 125 that is one-time aliasing position is detected as the azimuth of the target 121.

Here, referring to the relationship of the peak positions of the two spectrums 122 and 123, it may be determined that the aliasing occurs in the right direction. Thus, considering that the aliasing is one-time aliasing, it is possible to determine the real azimuth of the target 121 based on the azimuth detection process result (for example, the relationship of the peak positions of the two spectrums 122 and 123) by considering the aliasing. Thus, it is possible to achieve an effect substantially equivalent to a case where the azimuth detection range (FOV) is widened.

A simulation result relating to the radar apparatus 100 according to the present embodiment will be described with reference to FIGS. 6 and 7.

Part (a) of FIG. 6 is a diagram illustrating the relationship between a host vehicle 201 and a different vehicle 202 in simulation.

In this example, with respect to an axis of the forward direction (advancing direction) of the host vehicle 201 equipped with the radar apparatus 100 according to the present embodiment, the vehicle 202 that is a target is present on the left side by Y [m] (Y is a value larger than 0).

Part (b) of FIG. 6 is a diagram illustrating simulation conditions.

In this example, the number of reception antennas (the number of reception elements) is N (N is an integer that is equal to or greater than 3, for example), a central pitch d1 of the reception array antenna is d0+α (α is a value larger than 0, for example), pitches d2 at both ends of the reception array antenna are d0−α, and the resultant pitch (average pitch) of the reception array antenna is d0.

FIG. 7 is a diagram illustrating simulation results relating to the radar apparatus 100 according to an embodiment of the invention, which is mounted in the host vehicle 201.

In a graph shown in FIG. 7, the transverse axis represents a distance (detection distance [m]) from the target (different vehicle 202) detected by the radar apparatus 100 according to the present embodiment, and the longitudinal axis represents an azimuth angle (azimuth detection angle [deg]) of the target (different vehicle 202) detected by the radar apparatus 100 according to the present embodiment.

In Part (a) of FIG. 6, a case where the distance between the host vehicle 201 and the different vehicle 202 is gradually closer from a distant position is reflected to the graph.

In the graph shown in FIG. 7, in a range where the distance between the host vehicle 201 and the different vehicle 202 is between about R2 [m] (R2 is a value larger than 0) and about R1 [m] (R1 is a value larger than 0 and smaller than R2), the target (different vehicle 202) is present in the azimuth detection range (here, the common portion of the two azimuth detection ranges), and the azimuth detection result using the array A having irregular intervals that is the “A type” matches with the azimuth detection result using the array B having regular intervals that is the “B type”. The matched azimuth detection results are expressed as a curve 1001. Thus, the azimuth angle of the target in the azimuth detection range is detected.

On the other hand, if the distance between the host vehicle 201 and the different vehicle 202 is smaller than about R1 [m], the target (different vehicle 202) is come outside the azimuth detection range (here, the common portion of the two azimuth detection ranges), and the azimuth detection result (expressed as a curve 1002) using the array A having irregular interval array that is the “A type” does not match with the azimuth detection result (expressed as a curve 1003) using the array B having regular intervals that is “B type”. In this case, the azimuth angle of aliasing is detected.

A simulation result in a real machine relating to the radar apparatus 100 according to the present embodiment will be described with reference to FIGS. 8 and 9. In this example, in the azimuth detection process, the MCOV method is used.

Part (a) of FIG. 8 is a diagram illustrating the relationship between a host vehicle 301 and a CR (corner reflector) 302 in simulation in a real machine.

In this example, with respect to an axis of the forward direction (advancing direction) of the host vehicle 301 equipped with the radar apparatus 100 according to the present embodiment, the CR 302 that is a target is present on the left side by Y [m]. Furthermore, the host 301 passes through the CR 302 on its side.

Part (b) of FIG. 8 is a diagram illustrating simulation conditions in the real machine.

In this example, the number of reception antennas (the number of reception devices) is N (N is an integer that is equal to or greater than 3, for example), a central pitch d1 of the reception array antenna is d0+α (α is a value larger than 0, for example), pitches d2 at both ends of the reception array antenna are d0−α, and the resultant pitch (average pitch) of the reception array antenna is d0.

FIG. 9 is a diagram illustrating simulation results in the real machine relating to the radar apparatus 100 according to an embodiment of the invention.

In a graph shown in FIG. 9, the transverse axis represents a distance (detection distance [m]) from the target (CR 302) detected by the radar apparatus 100 according to the present embodiment, and the longitudinal axis represents an azimuth angle (azimuth detection angle [deg]) of the target (CR 302) detected by the radar apparatus 100 according to the present embodiment.

In Part (a) of FIG. 8, a case where the distance between the host vehicle 301 and the CR 302 is gradually closer from a distant position is reflected to the graph.

In the graph shown in FIG. 9, in a range where the distance between the vehicle 301 and the CR 302 is between about R2 [m] (R2 is a value larger than 0) and about R1 [m] (R1 is a value larger than 0 and smaller than R2), the target (CR 302) is present in the azimuth detection range (here, the common portion of the two azimuth detection ranges), and the azimuth detection result (expressed as a curve 1101) using the array A having irregular intervals that is “A type” and the azimuth detection result (expressed as a curve 1102) using the array B having regular intervals that is the “B type” match with a position (expressed as a curve 1103) of the azimuth angle of the real target.

Furthermore, if the distance between the host vehicle 301 and the CR 302 is about R1 [m], first, in the azimuth detection result (expressed as a curve 1104) using the array B having regular intervals that is the “B type”, aliasing begins.

Furthermore, if the distance between the host vehicle 301 and the CR 302 is smaller than about R1 [m], the target (CR 302) has come outside the azimuth detection ranges, and aliasing occurs in both of the azimuth detection result (expressed as a curve 1111) using the array A having irregular intervals that is the “A type” and the azimuth detection result (expressed as a curve 1112) using the array B having regular intervals that is the “B type”. Thus, the azimuth detection result (expressed as a curve 1111) using the array A having irregular intervals that is the “A type” and the azimuth detection result (expressed as a curve 1112) using the array B having regular intervals that is the “B type” do not match and deviate from each other. In this case, the azimuth angle of aliasing is detected.

As described above, in the on-board radar apparatus 100 according to the present embodiment, using the reception array antenna having irregular pitches in which the plurality of reception antennas 1-1 to 1-n are arranged at the different intervals d1 and d2, the azimuth detection of the target is performed in each of the antenna arrangements having two types of average intervals (average pitches) d0 and d1, it is mutually confirmed whether the respective azimuth detection results coincide with each other, and it is determined whether the target is present in or outside the azimuth detection range based on the confirmation result.

Accordingly, according to the on-board radar apparatus 100 according to the present embodiment, when the aliasing position of the target that is present outside one of the left and right sides of the azimuth detection range is detected, it is possible to determine the detection of the aliasing position, and for example, it is possible to exclude information about the aliasing position from the data on the target, or it is possible to detect the azimuth of the target considering that the aliasing is one-time aliasing.

In the on-board radar apparatus 100 according to the present embodiment, for example, it is possible to accurately determine whether the target that is present in the azimuth detection range is detected or the target that is present outside the azimuth detection range is detected at the aliasing position in the azimuth detection range, with high accuracy.

For example, in the azimuth detection according to the present embodiment, it is possible to substantially enlarge the azimuth detection range through software signal processing, and thus, the intervals of the reception antennas that form the reception array antenna should not necessarily be physically narrowed, or the number of the reception antennas that form the reception array antenna should not necessarily be increased.

Furthermore, in the related art, in the configuration in which the reflection level of the target is confirmed (determined) and it is determined whether the target is present in or outside the azimuth detection range, for example, there is a case where the target that is present in the azimuth detection range but has a small reflection level is mistakenly determined as a target that is present outside the azimuth detection range. On the other hand, in the azimuth detection according to the present embodiment, it is possible to logically determine whether the target is present in or outside the azimuth detection range, and thus, it is possible to accurately perform determination regardless of the reflection level of the target.

Furthermore, in the related art, for example, the configuration is used in which the host vehicle equipped with the on-board radar apparatus or the target (for example, different vehicle or the like) should be moved, change in the relative position of the target that is present outside the azimuth detection range and reduction in the reflection level of the target, sudden detection of the target at the aliasing position, or the like are determined together, and it is determined whether the target is present in or outside the azimuth detection range. On the other hand, in the azimuth detection according to the present embodiment, even though the host vehicle equipped with the on-board radar apparatus 100 is in a stop state and the target (for example, different vehicle or the like) is in a stop state, it is possible to determine whether the target is present in or outside the azimuth detection range.

Here, in the radar apparatus 100 according to the present embodiment, the reception array antenna having irregular pitches shown in Part (a) of FIG. 2 is provided, but instead, it is possible to provide and use various different reception array antennas.

For example, with respect to the reception array antenna, various types may be used with respect to the number of reception antennas, the intervals of adjacent reception antennas, or the like.

As an example, as the reception array antenna, two or more type of array antennas that are respectively configured by three or more reception antennas and have different average values (average pitch) of intervals of adjacent reception antennas, may be realized for use. The average pitches of the two or more types of array antennas do not have relationship of integral multiplication. Furthermore, the azimuth detection of the target is performed using respective arrangements of the two or more types of array antennas, and it is determined whether the target is present in the azimuth detection range (here, the common portions of the two azimuth detection ranges) according to whether the results match with each other.

Furthermore, as a preferable configuration example, with respect to the plurality of reception antennas that form the reception array antenna, the interval of adjacent reception antennas is set to a first interval with respect to a predetermined number of intervals from the center, and the interval of adjacent reception antennas is set to a second interval (for example, a value that is different from the first interval and does not have the relationship of integral multiplication with respect to the first interval) with respect to the remaining number of intervals that are present at both ends.

For example, if a difference between the part (the number of reception antennas) of the first interval and the part (the number of reception antennas) of the second interval is small, it is determined that the difference of the azimuth detection results using the respective two types of array antennas is small, and thus, it is considered that it is preferable to appropriately set these two parts (the numbers of reception antennas).

As a specific example, in six reception antennas that form the reception array antenna, the interval of adjacent reception antennas is set to the second interval with respect to only one interval at either end, and the interval of adjacent reception antennas is set to the first interval with respect to the remaining three intervals that are in the vicinity of the center.

Furthermore, as a specific example, in eight reception antennas that form the reception array antenna, the interval of adjacent reception antennas is set to the second interval with respect to only two intervals at either end, and the interval of adjacent reception antennas is set to the first interval with respect to the remaining three intervals that are in the vicinity of the center.

Furthermore, as a specific example, in eight reception antennas that form the reception array antenna, the interval of adjacent reception antennas is set to the second interval with respect to only one interval at either end, and the interval of adjacent reception antennas is set to the first interval with respect to the remaining five intervals that are in the vicinity of the center.

Generally, if the number of reception antennas that form the reception array antenna is increased, resolution in the transverse direction is enhanced. This is similarly applied to the reception array antenna having a regular pitch and to the reception array antenna having irregular pitches.

Furthermore, the azimuth detection range is generally determined by the average pitch of the reception antennas that form the reception array antenna. For example, if the average pitch is small, the azimuth detection range is enlarged, and resolution in the transverse direction is reduced.

The present embodiment of the invention has been described in detail with reference to the accompanying drawings, but a specific configuration is not limited to the embodiment, and design modification or the like in a range without departing from the spirit of the invention may be made.

Furthermore, a program for realizing the functions (for example, functions of one or more processing units among the azimuth detecting unit 31 or the other processing units 22 to 30 in the signal processing unit 20) of the radar apparatus 100 according to the above-described embodiment may be recorded in a computer-readable recording medium, and a computer system may read the program recorded in the recording medium to execute the program, to thereby perform the processes. Here, the “computer system” may include hardware such as an OS (operating system) or peripherals.

Furthermore, the “computer-readable recording medium” refers to a storage device such as a writable non-volatile memory such as a flexible disk, a magneto-optical disc, a ROM (Read Only Memory) or a flash memory, a movable medium such as a DVD (Digital Versatile Disk), or a hard disk built in the computer system.

Furthermore, the “computer-readable recording medium” may include a medium that stores a program for a predetermined time, such as a volatile memory (for example, DRAM (Dynamic Random Access Memory)) in a computer system that is a server or a client when the program is transmitted through a network such as the internet or a communication line such as a telephone line.

Furthermore, the program may be transmitted from a computer system that stores the program in a storage device or the like to a different computer system through a transmission medium or using transmission waves in the transmission medium. Here, the “transmission medium” that transmits the program refers to a medium having a function of transmitting information, such as a network (communication network) such as the internet or a communication line (communication cable) such as a telephone line.

Furthermore, the program may be a program for realizing a part of the above-mentioned functions. Furthermore, the program may be a so-called difference file (difference program) that is capable of implementing the above-described function by combination with a program that is stored in advance in the computer system.

What is claimed is:

1. An on-board radar apparatus comprising:
a plurality of reception antennas that form a reception array antenna that receives a reception wave obtained by causing an object to reflect a transmitted wave, the reception array antenna having two or more average pitches that do not have the relationship of integral multiplication; and
an azimuth detecting unit configured to perform an azimuth detection process of detecting an azimuth of the target based on signals received by the respective reception array antennas, and to determine that the detected azimuth of the target is a real azimuth when it is determined that the azimuths of the target detected based on the signals received by the respective reception array antennas coincide with each other and to determine that the detected azimuth of the target is a pseudo azimuth when it is determined that the azimuths of the target detected based on the signals received by the respective reception array antennas do not coincide with each other.

2. The on-board radar apparatus according to claim 1,
wherein the azimuth detecting unit determines that the target is present in an azimuth detection range in the azimuth detection process when the azimuths of the target detected based on the signals received by the respective reception array antennas coincide with each other, and determines that the target is present outside the azimuth detection range in the azimuth detection process when the azimuths of the target detected based on the signals received by the respective reception array antennas do not coincide with each other.

3. The on-board radar apparatus according to claim 1, further comprising:
a table configured to store matching of the position relationship between the azimuths of the target detected based on the signals received by the respective reception array antennas and an azimuth where the target is actually present, based on the assumption of one-time aliasing of the narrowest azimuth detection range in the azimuth detection process,
wherein when it is determined that the azimuths of the target detected based on the signals received by the respective reception array antennas do not coincide with each other, the azimuth detecting unit detects the azimuth where the target is actually present, based on the assumption of one-time aliasing of the narrowest azimuth detection range in the azimuth detection process, from the position relationship between the azimuths of the target detected based on the signals received by the respective reception array antennas based on the matching stored in the table.

4. An object detection method comprising:
using a plurality of reception antennas that form a reception array antenna that receives a reception wave obtained by causing an object to reflect a transmitted wave, the reception array antenna having two or more average pitches that does not have the relationship of integral multiplication; and
performing an azimuth detection process of detecting an azimuth of the target based on signals received by the respective reception array antennas, and determining that the detected azimuth of the target is a real azimuth when it is determined that the azimuths of the target detected based on the signals received by the respective reception array antennas coincide with each other and determining that the detected azimuth of the target is a pseudo azimuth when it is determined that the azimuths of the target detected based on the signals received by the respective reception array antennas do not coincide with each other, by an azimuth detecting unit.

5. An object detection program that causes a computer to execute a routine comprising:
using a plurality of reception antennas that form a reception array antenna that receives a reception wave obtained by causing an object to reflect a transmitted wave, the reception array antenna having two or more average pitches that does not have the relationship of integral multiplication; and
performing an azimuth detection process of detecting an azimuth of the target based on signals received by the respective reception array antennas, and determining that the detected azimuth of the target is a real azimuth when it is determined that the azimuths of the target detected based on the signals received by the respective reception array antennas coincide with each other and determining that the detected azimuth of the target is a pseudo azimuth when it is determined that the azimuths of the target detected based on the signals received by the respective reception array antennas do not coincide with each other, by an azimuth detecting unit.
